(19) United States
(12) Patent Application Publication
(10) Pub. No.: US 2026/0185645 A1
(43) Pub. Date: Jul. 2, 2026

(54) SYSTEM FOR DETERMINING CONDITIONS WITHIN A PIPELINE

(71) Applicant: Saudi Arabian Oil Company, Dhahran (SA)

(72) Inventors: Tariq A. Khathami, Dammam (SA); Abdullah M. Salma, Dammam (SA); Abdulrahman E. Sayed, Dammam (SA); Christian Canto Maya, Dhahran (SA)

(73) Assignee: Saudi Arabian Oil Company, Dhahran (SA)

(21) Appl. No.: 19/007,990

(22) Filed: Jan. 2, 2025

(51) Int. Cl. F16L 55/48; F16L 55/40; F16L 55/46; F16L 101/30

(52) U.S. Cl. CPC F16L 55/48; F16L 55/40; F16L 55/46; F16L 2101/30

(57) ABSTRACT

A system for determining conditions within a pipeline comprises a testing platform comprising a magnetically attractable component and at least one testing component, a magnetic positioning system comprising a platform engaging magnet and a three-dimensional positioner configured to position the platform engaging magnet longitudinally and circumferentially along an exterior surface of the pipeline, wherein the magnetic positioning system is configured to selectively maintain the testing platform at a plurality of positions within the pipeline via through-wall magnetic coupling between the platform engaging magnet and the magnetically attractable component of the testing platform.

### TECHNICAL FIELD

The present disclosure generally relates to systems and methods for determining conditions within a hollow structure and, more specifically, to systems and methods for determining conditions within a pipeline.

### BACKGROUND

In the petrochemical and petroleum industries, the integrity of pipelines and vessels is one of the most critical aspects that determines business continuity. The safety of complex pipeline systems, which are often located in challenging environments and remote locations, is critical in preventing disturbances in the transportation of energy resources. Ensuring the health of these pipelines is critical not only for preventing environmental and economical setbacks, but also for protecting human lives against potential equipment failures.

As global energy demands rise and infrastructure continues to age, the importance of accurate testing and detection technologies becomes increasingly important. Corrosion represents a worldwide challenge in the pipeline transportation, petroleum, and petrochemical industries as it threatens the integrity and shortens the lifetime of equipment and processing units used within these industries. The pipeline transportation industry represents a significant subsector of the petroleum and petrochemical industries where pipelines, sometimes hundreds of kilometers in length, are used to transport fluids from one place to another. Moreover, in the petroleum and petrochemical industries, corrosion may be found in a wide array of equipment types including, but not limited to, storage tanks, reactors, and separators.

In these industries, corrosion occurs when fluids within equipment and processing units react with and degrade the interior surfaces of these components. In addition to the corrosivity of the transported fluids themselves, there are several factors that can influence corrosion rate such as, for example, the presence of moisture in the pipeline as well as the presence of impurities in the fluids being transported. Over time, the degradation caused by corrosion can lead to several problems such as, for example, wall thinning, pitting, and stress cracking, each of which threatens the integrity of the pipeline and will ultimately lead to pipeline failure if left unaddressed. In severe cases, pipeline failure can result in product leakage, environmental contamination, and increased safety hazards.

However, there are various countermeasures that may be employed to prevent and/or reduce corrosion such as, for example, coating or lining the interior of the pipeline or processing unit with a corrosion resistant material, or adding corrosion inhibitors to fluids being transported/processed that forms a corrosion resistant film that protects the interior surfaces from direct contact with corrosive fluids. Additionally, corrosion coupons and other monitoring devices may be used to determine conditions within a pipeline or processing unit, for example, to monitor the extent and/or rate of corrosion.

### SUMMARY

Traditional pipeline monitoring methods have significant limitations, including complexity in deployment and challenges in accessing difficult locations within pipelines. Moreover, critical early warning signs can go undetected due to the limited reach of the detection and testing tools. For example, corrosion coupons and other monitoring devices are typically pre-installed at specific locations within a pipeline or processing unit. Corrosion coupons are small metallic samples made from the same material as the process unit/pipeline in which they are employed to monitor. Once installed at the specific location, corrosion coupons are left for a specific period of time and then retrieved to assess the condition of the metallic sample and determine how much mass it lost due to corrosion. Being made from the same material as the pipeline, the extent and/or rate of corrosion observed for the corrosion coupon (e.g., as indicated by mass loss) serves as a reliable indicator for the extent and/or rate of corrosion to the interior surfaces of the pipeline. However, these conventional coupons only provide corrosion information with respect to their pre-installed location and cannot be moved from one location to another to provide a broader picture of the corrosivity conditions within a pipeline or processing unit.

Similarly, conventional monitoring devices employing sensors, cameras, or other electronic devices are similarly limited with respect to their ability to provide a broader picture of the conditions within a pipeline or processing unit. Accordingly, there exists a need for improved systems and methods for determining conditions within pipelines and processing units in the pipeline transportation, petroleum, and petrochemical industries. Further, there exists a need for improved testing platforms that are movable within pipelines and processing units so as to enable more comprehensive monitoring of the conditions within said pipelines and processing units.

The present disclosure is directed to systems, methods, and movable testing platforms for determining conditions within pipelines and processing units. The movability of the testing platforms described herein enables the acquisition of a full range of information about the system to be tested, such as, for example, corrosion conditions and the extent of scale formation. In this manner, the systems and methods described herein allow for the creation a comprehensive profile which can be used to create a digital twin for the tested system.

Specifically, the systems and methods described herein employ a movable testing platform and a magnetic positioning system comprising a platform engaging magnet and a three-dimensional positioner configured to position the platform engaging magnet longitudinally and/or circumferentially along an exterior surface of the pipeline. The magnetic positioning system is configured to selectively maintain the testing platform at a plurality of positions within the pipeline via through-wall magnetic coupling between the platform engaging magnet and the magnetically attractable component of the testing platform.

Furthermore, the movable testing platforms of the present disclosure may be provided with multiple testing components for simultaneously measuring an array of conditions within a system. This platform can be inserted inside a pipeline, vessel, or any other suitable system where a testing component such as, for example, a sensor, corrosion coupon, or a camera, may be used to study system conditions of interest. For example, the systems, methods, and testing platforms described herein may be used to measure the rate of any type of material degradation within a pipeline or processing unit, such as, but not limited, to microbiologically influenced corrosion, deposits formation rate (e.g., scale formation rate), and erosion rate. Further, owing to the magnetic positioning system and corresponding features of the testing platforms described herein, and in contrast to conventional monitoring techniques, the systems, methods, and testing platforms of the present disclosure may be used to determine conditions at any desired location within a pipeline or processing unit.

In this manner, the systems, methods, and testing platforms described herein may be used to generate complete and comprehensive characterization profiles for the studied system by compiling conditions determined at a plurality of measurement positions within the pipeline or processing unit. These characterization profiles may be updated regularly or in real-time, thereby allowing for the creation of a digital twin for the system. The movability of the testing platforms described herein will solve critical issues that traditional stationary testing and detection tools are unable to solve.

According to a first aspect of the present disclosure, a system for determining conditions within a pipeline comprises a testing platform comprising a magnetically attractable component and at least one testing component, a magnetic positioning system comprising a platform engaging magnet and a three-dimensional positioner configured to position the platform engaging magnet longitudinally and circumferentially along an exterior surface of the pipeline, wherein the magnetic positioning system is configured to selectively maintain the testing platform at a plurality of positions within the pipeline via through-wall magnetic coupling between the platform engaging magnet and the magnetically attractable component of the testing platform.

A second aspect includes the first aspect, wherein the magnetically attractable component of the testing platform and the platform engaging magnet of the magnetic positioning system define a magnetic coupling force of at least about 0.039 newtons (N).

A third aspect includes either one of the first or second aspects, wherein the testing platform comprises a hollow enclosure, and wherein: the magnetically attractable component is associated with the hollow enclosure; and the at least one testing component is disposed within an interior portion of the hollow enclosure.

A fourth aspect includes the third aspect, wherein the hollow enclosure comprises the magnetically attractable component.

A fifth aspect includes the third aspect, wherein the magnetically attractable component is rigidly secured to the hollow enclosure.

A sixth aspect includes the third aspect, wherein the magnetically attractable component is tethered to the hollow enclosure.

A seventh aspect includes any one of the third through sixth aspects, wherein the interior portion of the hollow enclosure is fluidly sealed from an exterior portion of the hollow enclosure.

An eighth aspect includes any one of the third through sixth aspects, wherein the interior portion of the hollow enclosure is fluidly connected with an exterior portion of the hollow enclosure.

A ninth aspect includes either one of the first or second aspects, wherein the testing platform comprises: a base comprising the magnetically attractable component; and at least one attachment structure, wherein each attachment structure of the at least one attachment structure is configured for the attachment of a respective testing component of the at least one testing component.

A tenth aspect includes the ninth aspect, wherein the at least one attachment structure comprises a plurality of attachment structures configured for the attachment of respective testing components of the at least one testing component.

An eleventh aspect includes the tenth aspect, wherein: each of the plurality of attachment structures are coupled to the base via a respective support member; and the plurality of attachment structures are arranged in a radial array around the base.

A twelfth aspect includes any one of the first through eleventh aspects, wherein the at least one testing component comprises a sensor.

A thirteenth aspect includes the twelfth aspect, wherein the sensor comprises an ultrasonic sensor, a pressure sensor, or a temperature sensor.

A fourteenth aspect includes any one of the first through thirteenth aspects, wherein the at least one testing component comprises a camera.

A fifteenth aspect includes any one of the first through fourteenth aspects, further comprising an injection system configured to introduce the testing platform into the pipeline.

According to a sixteenth aspect of the present disclosure, a method for determining conditions within a pipeline comprises (a) positioning a platform engaging magnet at a first external position of the pipeline; (b) introducing a testing platform into the pipeline, the testing platform comprising a magnetically attractable component and at least one testing component; (c) attracting the testing platform to an initial position adjacent to the first external position via through-wall magnetic coupling between the platform engaging magnet and the magnetically attractable component of the testing platform; (d) moving the platform engaging magnet longitudinally and/or circumferentially along an exterior surface of the pipeline to a second external position of the pipeline, thereby causing movement of the testing platform to a measurement position adjacent to the second external position; and (e) performing at least one measurement at the measurement position with the at least one testing component to determine conditions associated with the measurement position.

A seventeenth aspect includes the sixteenth aspect, wherein the conditions comprise at least one of scale thickness, pressure, or temperature.

An eighteenth aspect includes either one of the sixteenth or seventeenth aspects, wherein the at least one testing component comprises a camera and the at least one measurement comprises at least one image.

A nineteenth aspect includes any one of the sixteenth through eighteenth aspects, wherein the platform engaging magnet is moved longitudinally and circumferentially along the exterior surface of the pipeline to the second external position of the pipeline.

A twentieth aspect includes any one of the sixteenth through nineteenth aspects, wherein (b) comprises introducing the testing platform into the pipeline using an injection system.

A twenty-first aspect includes any one of the sixteenth through twentieth aspects, wherein the method further comprises: further comprising: (f) moving the platform engaging magnet longitudinally and/or circumferentially along the exterior surface of the pipeline to another external position of the pipeline, thereby causing movement of the testing platform to another measurement position adjacent to the another external position of the pipeline; and (g) performing at least one measurement at the another measurement position with the at least one testing component to determine conditions associated with the another measurement position.

A twenty-second aspect includes the twenty-first aspect, wherein (f) and (g) are repeated a plurality of times to determine conditions at a plurality of measurement positions within the pipeline.

According to a twenty-third aspect of the present disclosure, a method for determining a characterization profile of a pipeline comprises: (h) performing the method of the twenty-second aspect; and (i) processing the conditions determined for the plurality of measurement positions to determine the characterization profile.

A twenty-fourth aspect includes the twenty-third aspect, where the method further comprises wirelessly transmitting signals associated with the conditions determined in (h) to a receiver that is external to the pipeline.

A twenty-fifth aspect includes either one of the twenty-third or twenty-fourth aspects, wherein the method further comprises: storing data associated with the conditions determined in (h) on a memory module of the testing platform; removing the testing platform from the pipeline; and extracting the data associated with the conditions determined in (h) from the memory module.

According to a twenty-sixth aspect of the present disclosure, a system for determining conditions within a hollow structure comprises a testing platform comprising a magnetically attractable component and at least one testing component, and a magnetic positioning system comprising a platform engaging magnet and a three-dimensional positioner configured to position the platform engaging magnet longitudinally and circumferentially along an exterior surface of the hollow structure, wherein the magnetic positioning system is configured to selectively maintain the testing platform at a plurality of positions within the hollow structure via through-wall magnetic coupling between the platform engaging magnet and the magnetically attractable component of the testing platform.

According to a twenty-seventh aspect of the present disclosure, a testing platform comprises: a hollow enclosure; a magnetically attractable component that is tethered to the hollow enclosure; and at least one testing component is disposed within an interior portion the hollow enclosure.

A twenty-eighth aspect includes the twenty-seventh aspect, wherein the interior portion of the hollow enclosure is fluidly sealed from an exterior portion of the hollow enclosure.

A twenty-ninth aspect includes the twenty-seventh aspect, wherein the interior portion of the hollow enclosure is fluidly connected with an exterior portion of the hollow enclosure.

According to a thirtieth aspect of the present disclosure, a testing platform comprises at least one testing component; and a base comprising a magnetically attractable component; and a plurality of attachment structures configured for the attachment of respective testing components of the at least one testing component, wherein: each of the plurality of attachment structures are coupled to the base via a respective support member; and the plurality of attachment structures are arranged in a radial array around the base.

Additional features and advantages of the technology disclosed herein will be set forth in the detailed description which follows, and in part will be readily apparent to those skilled in the art from that description or recognized by practicing the technology as described herein, including the detailed description which follows, the claims, as well as the appended drawings.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF THE DRAWINGS

FIG. 1 schematically depicts a system for determining conditions within in a pipeline, according to one or more embodiments described herein;

FIG. 2A schematically depicts an injection system for introducing a testing platform into a pipeline, at a first step of introducing the testing platform into the pipeline, according to one or more embodiments described herein;

FIG. 2B schematically depicts an injection system for introducing a testing platform into a pipeline, at a second step of introducing the testing platform into the pipeline, according to one or more embodiments described herein;

FIG. 3A schematically depicts an injection system for introducing a testing platform into a pipeline, at a third step of introducing the testing platform into the pipeline, according to one or more embodiments described herein;

FIG. 3B schematically depicts an injection system for introducing a testing platform into a pipeline, at a fourth step of introducing the testing platform into the pipeline, according to one or more embodiments described herein;

FIG. 4A schematically depicts an embodiment of a testing platform comprising a hollow enclosure, according to one or more embodiments described herein;

FIG. 4B schematically depicts another embodiment of a testing platform comprising a hollow enclosure, according to one or more embodiments described herein;

FIG. 4C schematically depicts an embodiment of a testing platform comprising a hollow enclosure wherein a magnetically attractable component of the testing platform is rigidly secured to the hollow enclosure, according to one or more embodiments described herein;

FIG. 5 schematically depicts an embodiment of a testing platform comprising a hollow enclosure wherein an interior portion of the hollow enclosure is fluidly connected with an exterior portion of the hollow enclosure, according to one or more embodiments described herein;

FIG. 6A schematically depicts an end view of a testing platform within a pipeline, the testing platform comprising a hollow enclosure wherein a magnetically attractable component of the testing platform is tethered to the hollow enclosure, according to one or more embodiments described herein;

FIG. 6B schematically depicts a perspective view from outside the pipeline of the embodiment shown in FIG. 6A;

FIG. 7A schematically depicts an embodiment of a testing platform having a base comprising a magnetically attractable component and an attachment structure (components shown as transparent), according to one or more embodiments described herein;

FIG. 7B schematically depicts the embodiment shown in FIG. 7A with the components shown as solid;

FIG. 7C schematically depicts the embodiment shown in FIG. 7A wherein a testing component of the testing platform is attached to the attachment structure, according to one or more embodiments described herein;

FIG. 8A schematically depicts an embodiment of a testing platform having a base comprising a magnetically attractable component and a plurality of attachment structures configured for the attachment of respective testing components, according to one or more embodiments described herein;

FIG. 8B schematically depicts the embodiment shown in FIG. 8A wherein a testing component of the testing platform is attached to an attachment structure of the plurality of attachment structures, according to one or more embodiments described herein; and

FIG. 9 schematically depicts a control system communicatively coupled to components of a system for determining conditions within in a pipeline, according to one or more embodiments described herein.

### DETAILED DESCRIPTION

Reference will now be made to systems and methods for determining conditions, for example, corrosivity conditions, within pipelines and processing units, as well as testing platforms that may be used with the systems and methods described herein.

As used herein, the term “corrosivity conditions” refers to conditions indicating the rate and/or extent of material degradation within a pipeline or processing unit. While measured for a particular material, fluid characteristics, and flow conditions, the corrosivity conditions determined by the systems and methods described herein may be used to assess the potential for corrosion of other materials exposed to the same fluid characteristics and flow conditions.

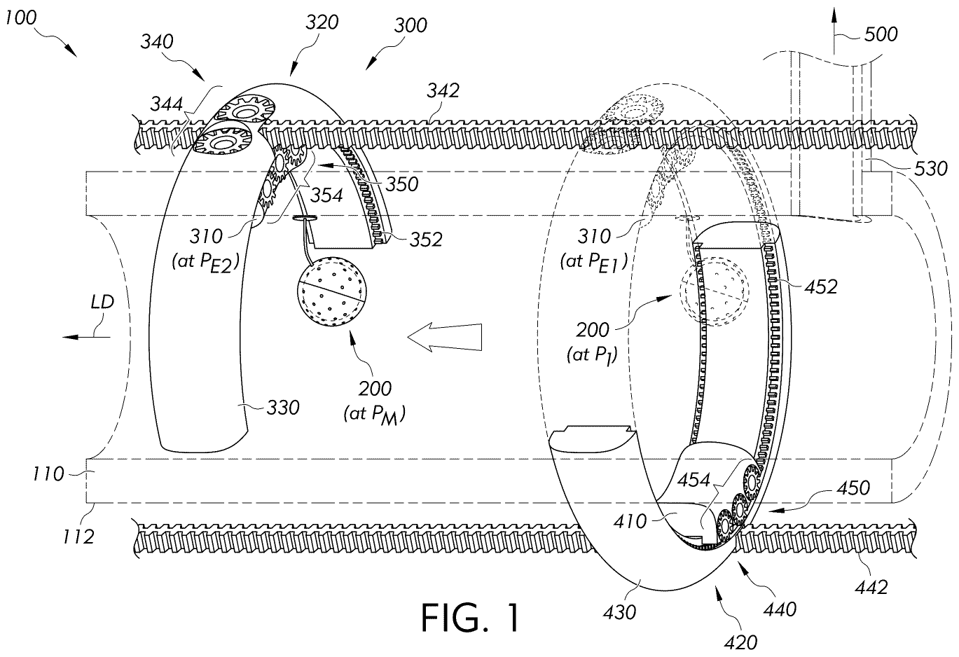

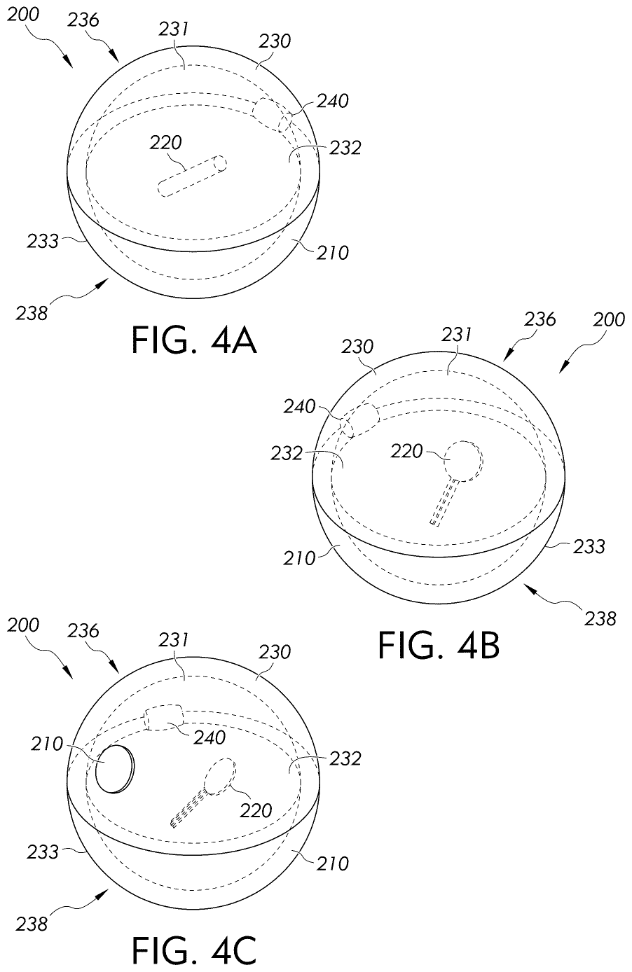

Referring now to FIGS. 1 and 4A, embodiments of a system 100 of the present disclosure for determining conditions within a pipeline 110 may include a testing platform 200 comprising a magnetically attractable component 210 and at least one testing component 220, and a magnetic positioning system 300 comprising a platform engaging magnet 310 and a three-dimensional positioner 320 configured to position the platform engaging magnet 310 longitudinally and circumferentially along an exterior surface 112 of the pipeline 110. The magnetic positioning system 300 is configured to selectively maintain the testing platform 200 at a plurality of positions within the pipeline 110 via through-wall magnetic coupling between the platform engaging magnet 310 and the magnetically attractable component 210 of the testing platform 200.

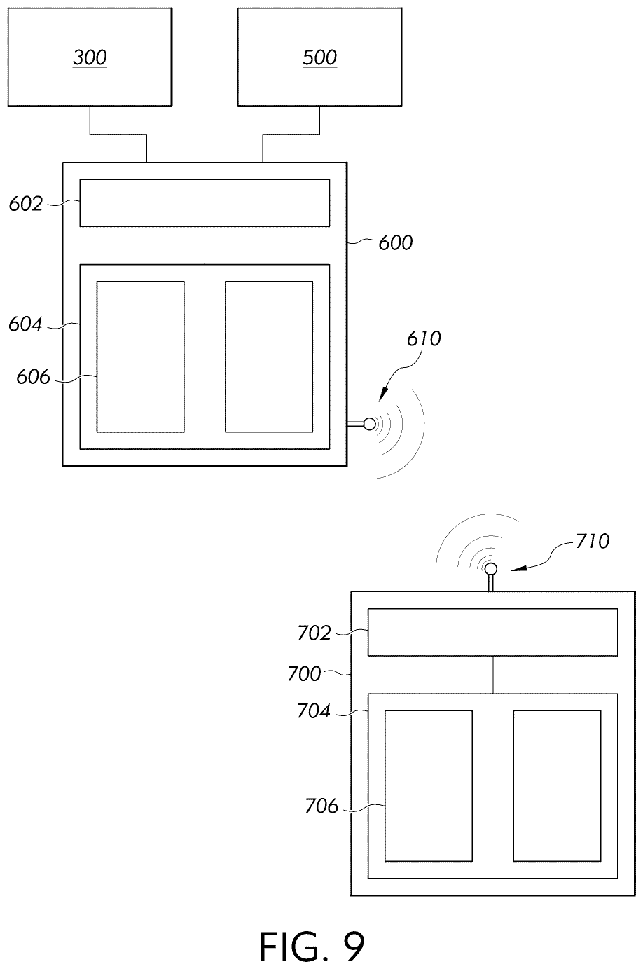

The at least one testing component 220 may comprise one or more of a pressure sensor, a temperature sensor, a ultrasonic sensor, a camera, a corrosion coupon, or another type of sensor that may be used to determine conditions within a pipeline 110 or processing unit in which the testing platform 200 is to be employed. The testing platform 200 may further comprise a testing platform control system 700 that is communicatively coupled with the at least one testing component 220 and a wireless transmitter 710 (see FIG. 9).

In embodiments, the three-dimensional positioner 320 may include magnet support arm 330, an axial positioner subassembly 340, and an angular positioner subassembly 350. The platform engaging magnet 310 may be movably coupled to the magnet support arm 330. The axial positioner subassembly 340 is configured to adjust the axial position of the platform engaging magnet 310 along the exterior surface 112 of the pipeline 110, and the angular positioner subassembly 350 is configured to adjust the circumferential position of the platform engaging magnet 310 along the exterior surface 112 of the pipeline 110. In this manner, the three-dimensional positioner 320 of the magnetic positioning system 300 is able to position the platform engaging magnet 310 longitudinally and circumferentially along an exterior surface 112 of the pipeline 110 via operation of the axial positioner subassembly 340 and the angular positioner subassembly 350.

In embodiments, the axial positioner subassembly 340 may include a linear gear track 342 coupled to the exterior surface 112 of the pipeline 110 and a first set of gears 344 coupled to the magnet support arm 330, as shown in FIG. 1. The first set of gears 344 may be further coupled to the linear gear track 342 such that rotation of the first set of gears 344 causes axial movement of the magnet support arm 330, and the platform engaging magnet 310 coupled thereto, along the longitudinal direction LD of the pipeline 110. In embodiments, the angular positioner subassembly 350 may include an arc-shaped gear track 352 coupled to the magnet support arm 330 and a second set of gears 354 coupled to the platform engaging magnet 310, as shown in FIG. 1. The second set of gears 354 may be further coupled to the arc-shaped gear track 352 such that rotation of the second set of gears 354 causes circumferential movement of the platform engaging magnet 310 along the exterior surface 112 of the pipeline 110.

In embodiments, the magnetic positioning system 300 further comprises a second platform engaging magnet 410 and a second three-dimensional positioner 420 configured to position the second platform engaging magnet 410 longitudinally and circumferentially along an exterior surface 112 of the pipeline 110. The second three-dimensional positioner 420 may include second magnet support arm 430, a second axial positioner subassembly 440, and a second angular positioner subassembly 450. The second platform engaging magnet 410 may be movably coupled to the second magnet support arm 430. The second axial positioner subassembly 440 is configured to adjust the axial position of the second platform engaging magnet 410 along the exterior surface 112 of the pipeline 110, and the second angular positioner subassembly 450 is configured to adjust the circumferential position of the second platform engaging magnet 410 along the exterior surface 112 of the pipeline 110. In this manner, the second three-dimensional positioner 420 of the magnetic positioning system 300 is able to position the second platform engaging magnet 410 longitudinally and circumferentially along an exterior surface 112 of the pipeline 110 via operation of the second axial positioner subassembly 440 and the second angular positioner subassembly 450.

In embodiments, the second axial positioner subassembly 440 may include a second linear gear track 442 coupled to the exterior surface 112 of the pipeline 110 and a third set of gears 444 coupled to the second magnet support arm 430, as shown in FIG. 1. The third set of gears 444 may be further coupled to the second linear gear track 442 such that rotation of the third set of gears 444 causes axial movement of the second magnet support arm 430, and the second platform engaging magnet 410 coupled thereto, along the longitudinal direction LD of the pipeline 110. In embodiments, the second angular positioner subassembly 450 may include a second arc-shaped gear track 452 coupled to the second magnet support arm 430 and a fourth set of gears 454 coupled to the second platform engaging magnet 410, as shown in FIG. 1. The fourth set of gears 454 may be further coupled to the second arc-shaped gear track 452 such that rotation of the fourth set of gears 454 causes circumferential movement of the second platform engaging magnet 410 along the exterior surface 112 of the pipeline 110. The three-dimensional positioner 320 and the second three-dimensional positioner 420 may be configured to pass the testing platform 200 back-and-forth between the three-dimensional positioner 320 and the second three-dimensional positioner 420 via movement of the first and second platform engaging magnets 310, 410 as well as activation/deactivation of the first and second platform engaging magnets 310, 410, which is discussed in more detail below.

As noted hereinabove, the platform engaging magnet 310 is configured to selectively maintain the testing platform 200 at a plurality of positions within the pipeline 110 via through-wall magnetic coupling between the platform engaging magnet 310 and the magnetically attractable component 210 of the testing platform 200. The platform engaging magnet 310 may be an electromagnet, a permanent magnet, or any other suitable magnet type. The platform engaging magnet 310 may be a permanent magnet if the platform engaging magnet 310 is capable of being maintained at sufficiently low temperatures (e.g., less than about 100° C.) so as to avoid losing its magnetism, such as, for example, wherein the pipeline being monitored for corrosion is a water utility pipe that has salt deposition on the interior surfaces. If the platform engaging magnet 310 is a permanent magnet, a magnetic switchable device may be used to turn on and off the external field of the magnet. If the platform engaging magnet 310 is an electromagnet, an electric current may be provided to the electromagnet to activate the platform engaging magnet 310 and cause the platform engaging magnet 310 to produce a magnetic field. The platform engaging magnet 310 may be deactivated by turning off and/or reducing the amount of electric current being supplied to the electromagnet.

The magnetic field produced by the platform engaging magnet 310 may be sufficient to attract the testing platform 200 to an initial position P₁ adjacent to the first external position P_{E1} via through-wall magnetic coupling between the platform engaging magnet 310 and the magnetically attractable component 210 of the testing platform 200. Further, the magnetic field produced by the platform engaging magnet 310 may be sufficient to maintain the testing platform 200 at the initial position P₁ under specified flow conditions, or a range of specified flow conditions, within the pipeline. Further, the magnetic field produced by the platform engaging magnet 310 may be sufficient such that when the platform engaging magnet 310 is moved longitudinally and/or circumferentially along an exterior surface 112 of the pipeline 110 to a second external position P_{E2} of the pipeline 110, a corresponding movement of the testing platform 200 occurs within the pipeline 110 so as to move the testing platform 200 to a measurement position P_{M} adjacent to the second external position P_{E2}.

The strength of the magnetic field produced by the platform engaging magnet 310 may be determined based on a number of considerations, such as, for example, the distance between the platform engaging magnet 310 and the magnetically attractable component 210 of the testing platform 200, as well as the weight, size, shape, and magnetic permeability of the magnetically attractable component 210. Additionally, characteristics of the fluid being transported within the pipeline 110 as well as characteristics of the testing platform 200 may also be taken into account. For example, the magnetic field produced by the platform engaging magnet 310 may be further determined based on the flow resistance applied to the testing platform 200 within the pipeline, as determined by the size, shape, and weight of the testing platform 200 as well as characteristics of the fluid flowing within the pipeline 110 such as, for example, the velocity, viscosity, and density of the fluid flowing within the pipeline 110. In embodiments wherein platform engaging magnet 310 is an electromagnetic, the magnetic field produced by the platform engaging magnet 310 may be adjustable based on the amount of electric current being supplied to the electromagnet.

In one or more embodiments, the magnetically attractable component 210 of the testing platform 200 and the platform engaging magnet 310 of the magnetic positioning system 300 define a magnetic coupling force of at least about 0.039 newtons (N) to control the position and/or movement of the testing platform 200 such that, for example, the magnetic positioning system 300 is able to maintain the testing platform 200 at positions within the pipeline 110 adjacent to the platform engaging magnet 310 that is external to the pipeline 110. For example, to achieve a magnetic coupling force of at least about 0.039 N when the magnetically attractable component 210 of the testing platform 200 is separated from the platform engaging magnet 310 by about 5 centimeters (cm), the platform engaging magnet 310 may be configured to have a magnetic field strength of about 0.035 tesla (T) at the position of the magnetically attractable component 210. As another example, to achieve a magnetic coupling force of at least about 0.039 N when the magnetically attractable component 210 of the testing platform 200 is separated from the platform engaging magnet 310 by about 10 cm, the platform engaging magnet 310 may be configured to have a magnetic field strength of about 0.28 T at the position of the magnetically attractable component 210. In such embodiments, the magnetically attractable component 210 of the testing platform 200 and the platform engaging magnet 310 of the magnetic positioning system 300 may define a magnetic coupling force of at least about 0.039 N at a spacing of about 5 cm to about 10 cm.

In one or more embodiments, the magnetically attractable component 210 of the testing platform 200 and the platform engaging magnet 310 of the magnetic positioning system 300 may define a magnetic coupling force of at least 0.039 N, at least 0.04 N, at least 0.05 N, at least 0.1 N, at least 0.5 N, at least 1.0 N, at least 2.0 N, at least 3.0 N, at least 4.0 N, or at least 5.0 N. In one or more embodiments, the magnetically attractable component 210 of the testing platform 200 and the platform engaging magnet 310 of the magnetic positioning system 300 may define a magnetic coupling force of greater than or equal to 0.039 N and less than or equal to 10 N, greater than or equal to 0.039 N and less than or equal to 5.0 N, greater than or equal to 0.039 N and less than or equal to 4.0 N, greater than or equal to 0.039 N and less than or equal to 3.0 N, greater than or equal to 0.039 N and less than or equal to 2.0 N, or greater than or equal to 0.039 N and less than or equal to 1.0 N.

In one or more embodiments, the magnetically attractable component 210 of the testing platform 200 and the platform engaging magnet 310 of the magnetic positioning system 300 may define a magnetic coupling force of greater than or equal to 0.04 N and less than or equal to 5.0 N, greater than or equal to 0.05 N and less than or equal to 5.0 N, greater than or equal to 0.1 N and less than or equal to 5.0 N, greater than or equal to 0.5 N and less than or equal to 5.0 N, or greater than or equal to 1.0 N and less than or equal to 5.0 N. Further, as noted above, to achieve a particular magnetic coupling force between the magnetically attractable component 210 of the testing platform 200 and the platform engaging magnet 310 of the magnetic positioning system 300, the strength of the magnetic field produced by the platform engaging magnet 310 may be set and/or adjusted based the spacing between the magnetically attractable component 210 of the testing platform 200 and the platform engaging magnet 310 of the magnetic positioning system 300, characteristics of the fluid being transported within the pipeline 110, as well as characteristics of the testing platform 200. For example, for a testing platform 200 having a weight between 4 grams and 6 grams in a pipeline having a fluid flow rate of between 0 m³/s and 0.5 m³/s, the magnetically attractable component 210 of the testing platform 200 and the platform engaging magnet 310 of the magnetic positioning system 300 may define a magnetic coupling force of between 0.039 N and 0.065 N.

In embodiments, the magnetically attractable component 210 of the testing platform 200 may be made from a ferromagnetic material (e.g., steel) or a paramagnetic material, provided that the magnetic permeability of the magnetically attractable component 210 allows for a magnetic coupling force between the platform engaging magnet 310 and the magnetically attractable component 210 that is sufficient to attract and maintain the testing platform 200 to positions within the pipeline 110 adjacent to the platform engaging magnet 310 positioned external to the pipeline 110.

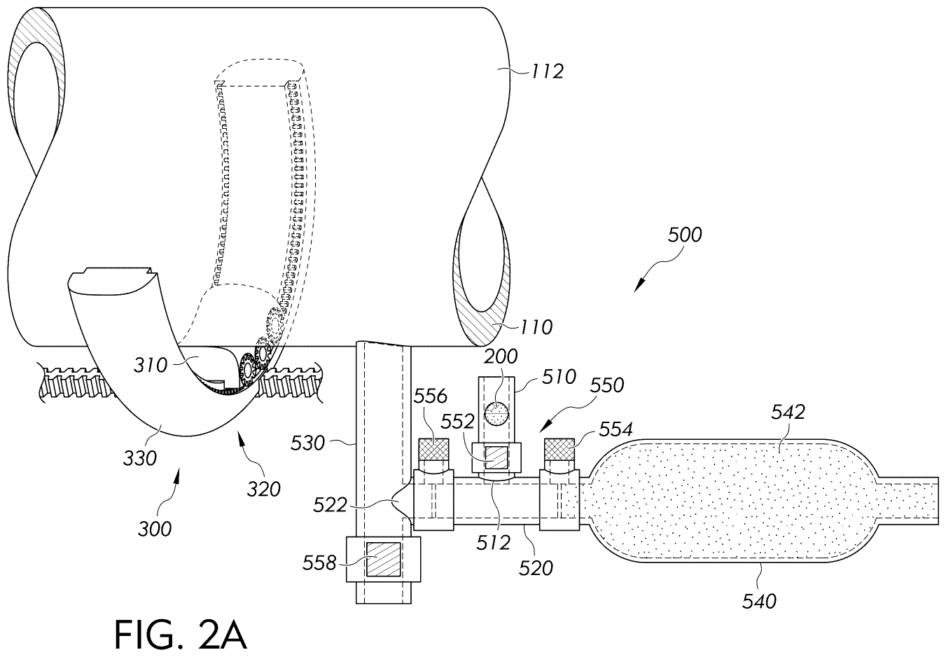

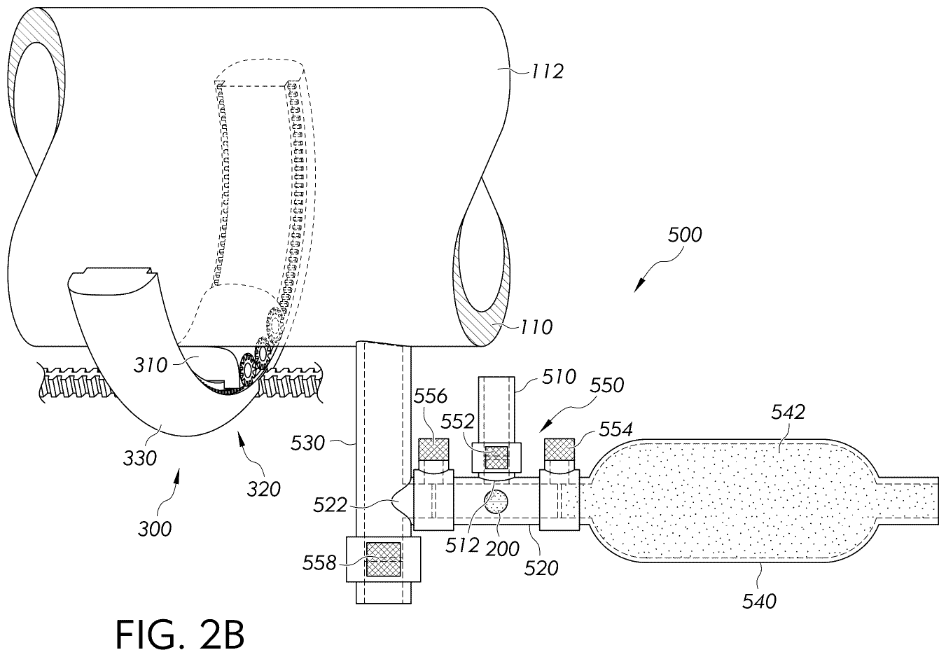

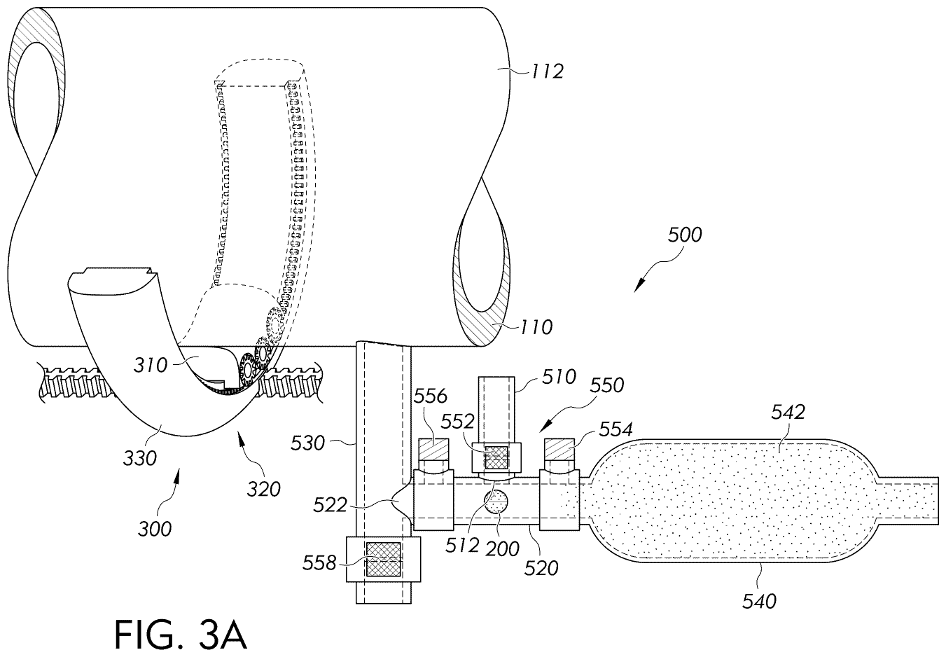

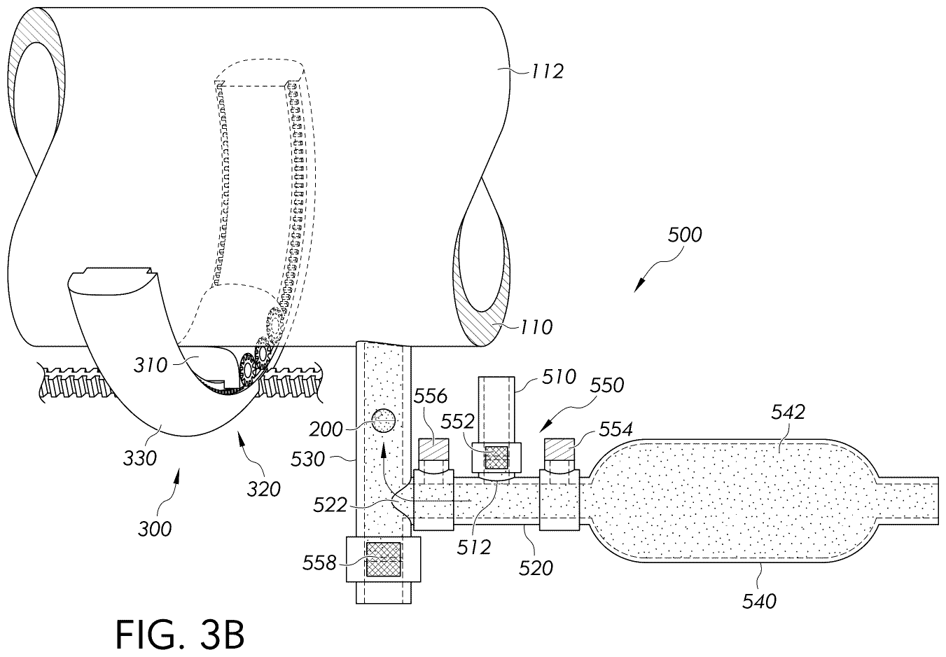

Referring now to FIGS. 2A-3B, the system 100 for determining conditions within a pipeline 110 may further include an injection system 500 configured to introduce the testing platform 200 into the pipeline 110. The injection system 500 may include a first channel 510 to which the testing platform 200 may be introduced to the injection system 500. The injection system 500 may further include a second channel 520 to which the first channel 510 is coupled. The second channel 520 may be coupled at one end to a third channel 530 and at the other end to a carrier fluid tank 540 containing a carrier fluid 542. The carrier fluid 542 may be the same fluid being transported through the pipeline 110 or any other suitable fluid that is able to transport the testing platform 200 through the injection system 500 and into the pipeline 110. The injection system 500 may further include a valve system 550 configured to allow for the controlled introduction of the testing platform 200 into the pipeline 110.

The valve system 550 may include a first channel valve 552 coupled to the first channel 510 such that opening and closing of the first channel valve allows 552 fluid and the testing platform 200 within the first channel to be transported into the second channel 520. The valve system 550 may further include a second channel upstream valve 554 and a second channel downstream valve 556. The second channel upstream valve may 554 be positioned between a first coupling point 512 of the first channel 510 to the second channel 520 and the carrier fluid tank 540, as shown in FIG. 2A. The second channel downstream valve 556 may be positioned between the first coupling point 512 and a second coupling point 522 of the second channel 520 to the third channel 530. After the testing platform 200 has been introduced into the second channel 520, and after the first channel valve 552 has been closed, as shown in FIG. 2B, the second channel upstream valve 554 and the second channel downstream valve 556 may be opened to allow carrier fluid 542 from the carrier fluid tank 540 to flow through the second channel 520 and into the third channel 530 coupled thereto, thereby causing the testing platform 200 to flow from the second channel 520 into the third channel 530 and then into the pipeline 110, as shown in FIGS. 3A and 3B. The valve system 550 may further include a third channel valve 558 coupled to the third channel 530, which may be opened and closed to adjust the flow of carrier fluid 542 through the third channel 530 as it carriers the testing platform 200 into the pipeline 110.

The system 100 may further include an extraction system (not shown in figures) configured to extract the testing platform 200 from the pipeline 110. For example, a net or other suitable device may be inserted through a side channel that is coupled to the pipeline 110 at an extraction location. In embodiments, the magnetic positioning system 300 may be configured to guide the testing platform 200 to the extraction system where the weight loss of the testing platform 200 and/or other corrosion related characteristics may be automatically measured and reported.

With reference now to FIG. 9, the system 100 may further include a control system 600 communicatively coupled to the magnetic positioning system 300 and the injection system 500. The control system 600 may include at least one processor 602, at least one memory module 604 communicatively coupled to the processor 602, and machine readable and executable instructions 606 stored on the memory module(s) 604. The control system 600 may further include a wireless receiver 610 for wireless communication with a wireless transmitter 710 of the testing platform 200.

The machine readable and executable instructions 606, when executed by the processor 602, may control operation of the platform engaging magnet 310 by, for example, activating and deactivating the platform engaging magnet 310 so as to attract and release the testing platform 200 from adjacent positions within the pipeline 110. Further, the machine readable and executable instructions 606, when executed by the processor 602, may control operation of the magnetic positioning system 300 to position the platform engaging magnet longitudinally and circumferentially along an exterior surface of the pipeline. In this manner, the control system 600 is able to selectively maintain the testing platform 200 at a plurality of positions within the pipeline 110 via through-wall magnetic coupling between the platform engaging magnet 310 and the magnetically attractable component 210 of the testing platform 200. In embodiments wherein the magnetic positioning system 300 includes a second platform engaging magnet 410 and second three-dimensional positioner 420, the control system 600 may be used to control operation of the second platform engaging magnet 410 and second three-dimensional positioner 420 in the same manner as described above for the platform engaging magnet 310 and three-dimensional positioner 320.

Furthermore, the machine readable and executable instructions 606, when executed by the processor 602, may control operation of the injection system 500 and the valve system 550 thereof to introduce the testing platform 200 into the pipeline 110 in the manner described above.

As noted above, the control system 600 may include the one or more processors 602 and one or more memory modules 604. The one or more processors 602 may include any device capable of executing computer-readable executable instructions stored on a non-transitory computer-readable medium. Accordingly, each processor 602 may include an integrated circuit, a microchip, a computer, and/or any other computing device. The one or more memory modules 604 are communicatively coupled to the one or more processors 602 over a communication path. The one or more memory modules 604 may be configured as volatile and/or nonvolatile memory and, as such, may include random access memory (including SRAM, DRAM, and/or other types of RAM), flash memory, secure digital (SD) memory, registers, compact discs (CD), digital versatile discs (DVD), and/or other types of non-transitory computer-readable mediums. The one or more memory modules 604 may be configured to store machine readable and executable instructions 606 for operating one or more components of the system 100.

Embodiments of the present disclosure include logic stored on the one or more memory modules 604 that includes machine-readable and executable instructions or an algorithm written in any programming language of any generation (e.g., 1GL, 2GL, 3GL, 4GL, and/or 5GL) such as, machine language that may be directly executed by the one or more processors 302, assembly language, obstacle-oriented programming (OOP), scripting languages, microcode, etc., that may be compiled or assembled into machine readable instructions and stored on a machine readable medium. Similarly, the logic and/or algorithm may be written in a hardware description language (HDL), such as logic implemented via either a field-programmable gate array (FPGA) configuration or an application-specific integrated circuit (ASIC), and their equivalents. Accordingly, the logic may be implemented in any conventional computer programming language, as pre-programmed hardware elements, and/or as a combination of hardware and software components.

Embodiments of the testing platform 200 will now be described in more detail. As noted hereinabove, the testing platform 200 comprises a magnetically attractable component 210 and at least one testing component 220. Referring now to FIGS. 4A-6B, in embodiments, the testing platform 200 comprises a hollow enclosure 230 wherein the magnetically attractable component 210 is associated with the hollow enclosure 230, and the at least one testing component 220 is disposed within an interior portion 231 of the hollow enclosure 230. The hollow enclosure 230 may include a central support structure 232, e.g., a central disc, that is configured for the installation of the at least one testing component 220. Moreover, the hollow enclosure 230 may comprise a first enclosure member 236 and a second enclosure member 238 that can be separated from each other to open the hollow enclosure 230 and access the interior portion 231.

In the embodiments shown in FIGS. 4A-4C, the interior portion 231 of the hollow enclosure 230 is fluidly sealed from an exterior portion of the hollow enclosure 230. This may be an important design feature when a testing component 220 of the testing platform 200 must be isolated from the fluid environment in which the testing platform 200 is to be placed. For example, in embodiments, the testing component 220 may comprise a sensor that cannot be in direct contact with the fluid inside the pipeline 110. Further, while not shown in the figures, a sealing member such as an O-ring may be provided between the first and second enclosure members 236, 238 to prevent fluid within the pipeline 110 from entering the interior portion 231 of the hollow enclosure 230. Additionally, the hollow enclosure 230 may be provided with a locking device 240 that prevents the hollow enclosure 230 from opening during operation and permits the opening of the hollow enclosure 230 only after the testing platform 200 has been extracted from the pipeline 110.

In the embodiment shown in FIG. 4A, the hollow enclosure 230 itself comprises the magnetically attractable component 210, e.g., the enclosure wall 233 defining the outer shape of the hollow enclosure 230 is formed from a ferromagnetic material. In embodiments, the enclosure wall 233 is fully constructed from a ferromagnetic material. In one or more embodiments, such as the embodiment shown in FIG. 4A, the at least one testing component 220 may include any type of sensor, coupon, or other suitable testing/measurement device such as, for example, a pressure sensor, a temperature sensor, an acoustic sensor, a magnetic flux sensor, an accelerometer, a gyroscope, an optical sensor, an ultrasonic sensor, a chemical sensor, or combinations thereof. In the embodiment shown in FIG. 4B, the at least one testing component 220 is a pressure sensor such as, for example, a piezoelectric pressure sensor.

In some embodiments, the hollow enclosure 230 of the testing platform 200 may be coupled to the magnetically attractable component 210. For example, in the embodiment shown in FIG. 4C, the magnetically attractable component 210 is rigidly secured to the enclosure wall 233 of the hollow enclosure 230 (e.g., via screws or an adhesive).

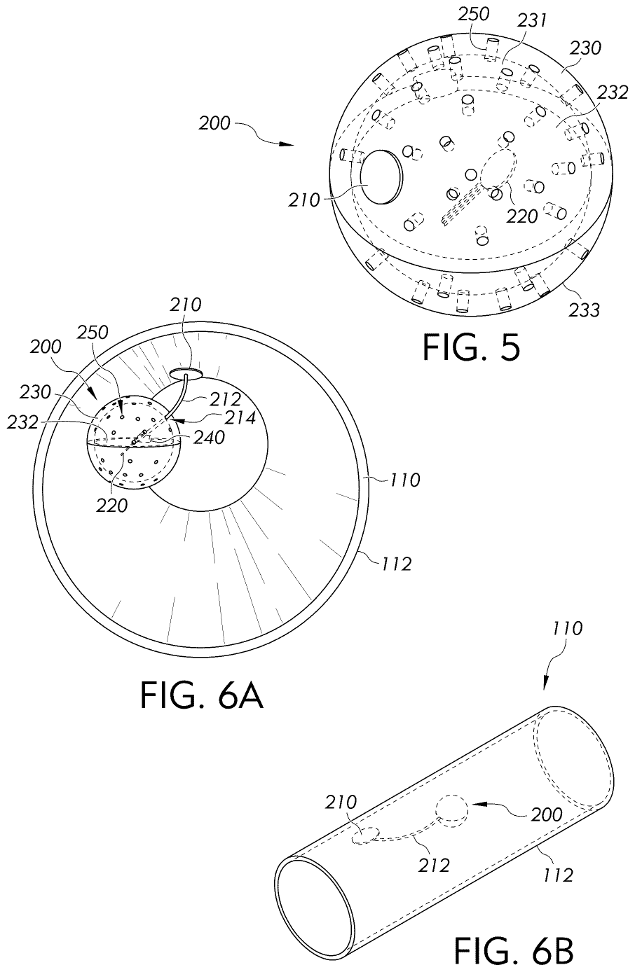

Referring now to FIG. 5, in another embodiment, the interior portion 231 of the hollow enclosure 230 is fluidly connected with an exterior portion of the hollow enclosure 230, for example, via a plurality of fluid channels 250 that allow fluid within the pipeline 110 to enter and exit the interior portion 231 of the hollow enclosure 230. Fluid connectivity with the exterior portion of the hollow enclosure 230 may be an important design feature when a testing component 220 of the testing platform 200 needs to be fully exposed and in direct contact with the fluid inside the pipeline 110. The diameter of the fluid channels 250 may be adjusted in view of any fluid exchange and fluid flow requirements of the at least one testing component 220.

Referring now to FIGS. 6A and 6B, in another embodiment, the magnetically attractable component 210 may be tethered to the hollow enclosure 230 via a tether 212. This may be an important design feature when the testing platform 200 requires less exposure to the magnetic field of the platform engaging magnet 310. For example, some sensors employed as testing components 220 may be sensitive to magnetic fields and require a larger separation from the magnetic field of the platform engaging magnet 310 than provided by the thickness of the wall of the pipeline 110. Further, it may be beneficial for certain sensors to be positioned more centrally within the pipeline 110. This may be the case in embodiments wherein the interior portion 231 of the hollow enclosure 230 is fluidly connected with an exterior portion of the hollow enclosure 230 (see FIG. 5), or in embodiments wherein the interior portion 231 of hollow enclosure is fluidly sealed from an exterior portion of the hollow enclosure 230 (FIGS. 4A-4C). The tether 212 may comprise any suitable structure that is mechanically and materially suitable in the environment such as, for example, a chain, a rope, or a cable. In the embodiment shown in FIGS. 6A and 6B, the enclosure wall 233 includes a tether opening 214 where the tether 212 may extend through and be secured to a component (e.g., the central support structure 232) within the hollow enclosure 230. However, in other embodiments, the tether 212 may be secured directly to the enclosure wall 233.

While the embodiments in FIGS. 4A-6B show the enclosure wall 233 having a substantially spherical shape, it should be understood that the shape of the enclosure wall 233 may be provided with other shapes as well, e.g., a cubical shape. Moreover, it should be understood that the thickness and material of the enclosure wall 233 may be selected in view of the fluid characteristics and flow conditions within the system in which the testing platform 200 is to be employed.

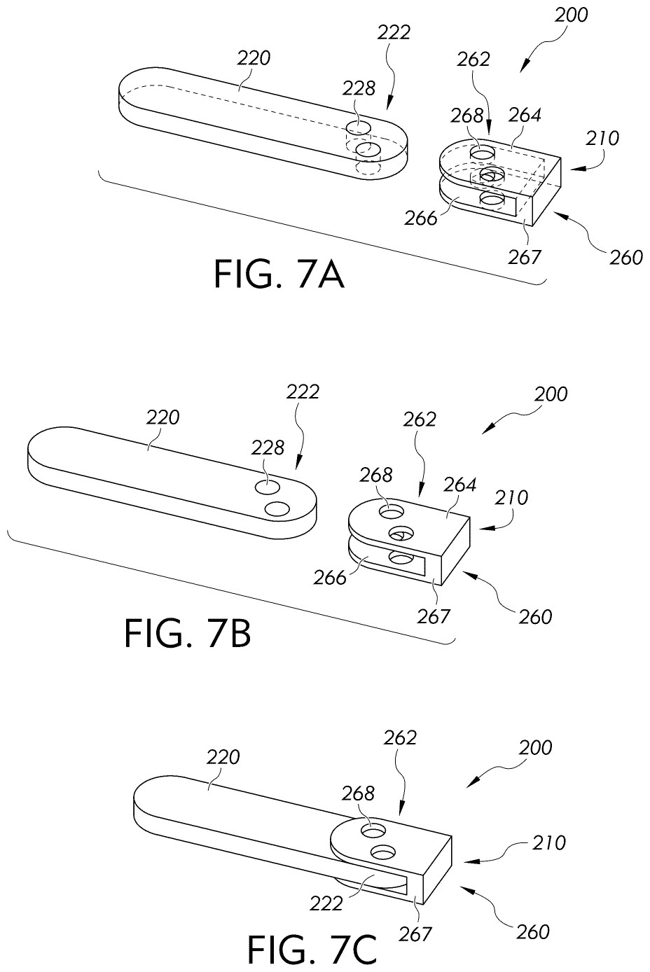

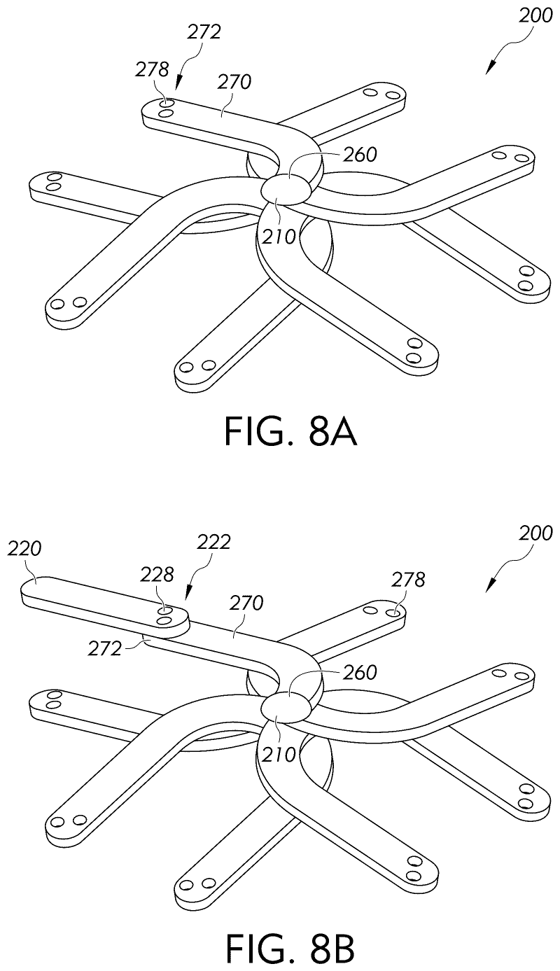

Referring now to FIGS. 7A-8B, in other embodiments, the testing platform 200 comprises a base 260 comprising the magnetically attractable component 210 and at least one attachment structure 262, wherein each attachment structure 262 of the at least one attachment structure 262 is configured for the attachment of a respective testing component 220 of the at least one testing component 220. The testing platform 200 shown in FIGS. 7A-8B may be implemented when the testing component 220 of the testing platform 200 needs to be fully exposed and in direct contact with the fluid inside the pipeline 110. Further, the testing platform shown in FIGS. 7A-8B may be beneficial when a testing component 220 needs to be fully or partially constructed from a specific material that is not ferromagnetic, such as, but not limited to, a non-ferromagnetic corrosion coupon.

In the embodiment shown in FIGS. 7A-7C, the attachment structure 262 comprises a first wall 264 and a second wall 266 each extending from an end portion 267 of the base 260. The first wall 264 and the second wall 266 may be coplanar and separated by a spacing that allows for the insertion of a corresponding attachment end 222 of a testing component 220. Further, the first wall 264 and the second wall 266 may have aligning sets of holes 268, and the attachment end 222 of the testing component 220 may have a corresponding set of holes 228 such that when the holes 228 of the attachment end 222 of the testing component 220 are aligned with the holes 268 of the first and second walls 264, 266 of the base 260, pins or bolts (not shown) may be used to secure the testing component 220 to the attachment structure 262.

Referring now to FIGS. 8A and 8B, in another embodiment, the testing platform 200 comprises a base 260 comprising the magnetically attractable component 210 and a plurality of attachment structures 272 configured for the attachment of respective testing components 220 of the at least one testing component 220. As shown in FIGS. 8A and 8B, each of the plurality of attachment structures 272 may be coupled to the base 260 via a respective support member 270. In the embodiment shown in FIGS. 8A and 8B, the attachment structures 272 form end portions of their respective support members 270. Further, as shown in FIGS. 8A and 8B, the plurality of attachment structures 272 may be arranged in a radial array around the base 260. Each attachment structure 272 may include a set of holes 278 such that when the holes 228 of the attachment end 222 of the testing component 220 are aligned with the holes 278 of the attachment structure 272, pins or bolts (not shown) may be used to secure the testing component 220 to the attachment structure 272. The embodiment depicted in FIGS. 8A and 8B may be beneficial when the testing platform 200 is to be provided with a plurality of testing components 220, e.g., a plurality of corrosion coupons.

While not depicted in FIGS. 4A-8B, the testing platforms 200 of the present disclosure may further comprise a testing platform control system 700 including one or more processors 702 and one or more memory modules 704. The one or more processors 702 may include any device capable of executing computer-readable executable instructions stored on a non-transitory computer-readable medium. Accordingly, each processor 702 may include an integrated circuit, a microchip, a computer, and/or any other computing device. The one or more memory modules 704 are communicatively coupled to the one or more processors 702 over a communication path. The one or more memory modules 704 may be configured as volatile and/or nonvolatile memory and, as such, may include random access memory (including SRAM, DRAM, and/or other types of RAM), flash memory, secure digital (SD) memory, registers, compact discs (CD), digital versatile discs (DVD), and/or other types of non-transitory computer-readable mediums. The one or more memory modules 604 may be configured to store machine readable and executable instructions 706 for operating one or more components of the testing platform 200.

The testing platform control system 700 may be communicatively coupled to the testing component(s) of at least one testing component 220 such that data obtained from measurements performed by the testing component(s) may be stored on a memory module(s) of the one or more memory modules 704. This data may later be extracted from the memory module(s) upon removal of the testing platform 200 from the system being studied. In other embodiments, the testing platform control system 700 may further include a wireless transmitter (710) for wireless communication with an wireless receiver (610) of the control system 600. This design enables real-time communication between the testing platform 200 and the control system 600 such that the system 100 for determining conditions within a pipeline 110 is able to produce a real-time digital twin of the pipeline 110 with a full characterization profile.

Embodiments of the present disclosure are also directed to methods for determining conditions within a pipeline 110. In embodiments, methods for determining conditions within a pipeline 110 include: positioning a platform engaging magnet 310 at a first external position P_{E1} of the pipeline 110; (b) introducing a testing platform 200 into the pipeline 110, the testing platform 200 comprising a magnetically attractable component 210 and at least one testing component 220; (c) attracting the testing platform 200 to an initial position P₁ adjacent to the first external position P_{E1} via through-wall magnetic coupling between the platform engaging magnet 310 and the magnetically attractable component 210 of the testing platform 200; (d) moving the platform engaging magnet 310 longitudinally and/or circumferentially along an exterior surface 112 of the pipeline 110 to a second external position P_{E2} of the pipeline 110, thereby causing movement of the testing platform 200 to a measurement position P_{M} adjacent to the second external position P_{E2}; and (e) performing at least one measurement at the measurement position P_{M} with the at least one testing component 220 to determine conditions associated with the measurement position P_{M}.

In the methods of the present disclosure for determining conditions within a pipeline 110, any of the embodiments described herein with respect to the system 100 and the testing platforms 200 may be utilized. In embodiments, the conditions determined in the methods described herein may include at least one of scale thickness, pressure, temperature, or corrosivity. In other embodiments, the conditions in the methods described herein may include at least one of scale thickness, pressure, or temperature. In embodiments, the at least one testing 200 component may comprise a camera and the at least one measurement comprises at least one image.

In embodiments, the methods for determining conditions within a pipeline 110 may further comprise: (f) moving the platform engaging magnet longitudinally and/or circumferentially along the exterior surface of the pipeline to another external position of the pipeline, thereby causing movement of the testing platform to another measurement position adjacent to the another external position of the pipeline; and (g) performing at least one measurement at the another measurement position with the at least one testing component to determine conditions associated with the another measurement position.

Additionally, the methods may further comprise repeating (f) and (g) a plurality of times to determine conditions at a plurality of measurement positions within the pipeline 110. Finally, embodiments of the present disclosure also include methods for determining a characterization profile of a pipeline 110 wherein the above steps (a)-(g) are performed, with steps (f) and (g) being repeated a plurality of times, and then processing the conditions for the plurality of measurement positions to determine the characterization profile. Moreover, as described above with respect to the systems 100 of the present disclosure, the methods may further include storing data associated with the determined conditions on a memory module of the testing platform 200, removing the testing platform 200 from the pipeline 110, and then extracting the data from the memory module. Additionally and/or alternatively, the methods described herein may also include wirelessly transmitting signals associated with the conditions determined by the testing platform to a receiver that is external to the pipeline.

In embodiments wherein the testing platform 200 comprises a corrosion coupon as a testing component 220, the testing platform 200 may be maintained, via through-wall magnetic coupling between the platform engaging magnet 310 and the magnetically attractable component 210 of the testing platform 200, at the measurement position P_{M} for a test duration such that the corrosion coupon acquires modified characteristics different from its initial characteristics. Thereafter, when the testing platform 200 is extracted from the pipeline 110, information regarding the corrosivity conditions within the pipeline may be determined by comparing the initial characteristics of the corrosion coupon to the modified characteristics. In embodiments, the initial characteristics of the corrosion coupon may comprise an initial weight of the corrosion coupon, the modified characteristics of the corrosion coupon may comprise a modified weight of the corrosion coupon, and comparing the initial and modified characteristics of the corrosion coupon may comprise determining a difference between the initial weight of the corrosion coupon and the modified weight of the corrosion coupon.

In other embodiments of the methods described herein wherein the testing platform 200 comprises a corrosion coupon as a testing component 220, the initial characteristics of the corrosion coupon may comprise an initial surface condition of the corrosion coupon (e.g., characterized by well-known microscopy methods), the modified characteristics of the corrosion coupon may comprise a modified surface condition of the corrosion coupon, and comparing the initial and modified characteristics of the corrosion coupon may comprise comparing the modified surface condition of the corrosion coupon to the initial surface condition of the corrosion coupon.

In embodiments of the methods described herein, the platform engaging magnet 310 may be moved longitudinally and circumferentially along the exterior surface of the pipeline 110 to the second external position P_{E2} of the pipeline 110. Further, (b) in the above-described embodiment may comprise introducing the testing platform 200 into the pipeline 110 using the injection system 500.

While the three-dimensional positioner 320 is described herein with respect to the embodiment shown in FIG. 1, embodiments of the system 100 also include other three-dimensional positioner systems, such as, for example, the robot systems described in U.S. patent application Ser. No. 18/501,631 , entitled “Robots for Servicing Metal Equipment,” the entire contents of which are incorporated herein by reference.

Furthermore, while embodiments of the system 100 are described with respect to a pipeline 110, the present disclosure is also directed to systems for determining conditions within a hollow structure, such as but not limited, storage tanks, reactors, pressure vessels, or other hollow structures, that contact fluids during typical use.

Unless otherwise specified, a range of values, when recited, includes both the upper and lower limits of the range as well as any sub-ranges therebetween. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

As used herein, the indefinite articles “a,” “an,” and the corresponding definite article “the” mean “at least one” or “one or more,” unless otherwise specified. It will also be understood that the various features disclosed in the specification and the drawings can be used in any and all combinations.

As used herein and in the appended claims, the words “comprise,” “has,” and “include” and all grammatical variations thereof are each intended to have an open, non-limiting meaning that does not exclude additional elements or steps.

Reference throughout this specification to “one embodiment,” “embodiments,” “certain embodiments,” “some embodiments,” “various embodiments,” “one or more embodiments,” or “an embodiment” means that a particular feature, structure, material, or characteristic described in connection with the embodiment is included in at least one embodiment of the disclosure. Thus, the appearances of the phrases such as “in embodiments,” “in one or more embodiments,” “in certain embodiments,” “in various embodiments,” “in one embodiment,” “in some embodiments,” or “in an embodiment” in various places throughout this specification are not necessarily referring to the same embodiment. Furthermore, the particular features, structures, materials, or characteristics described in connection with one embodiment may be combined in any suitable manner in one or more other embodiments.

It will be apparent to those skilled in the art that various modifications and variations can be made to the embodiments described herein without departing from the spirit and scope of the claimed subject matter. Thus it is intended that the specification cover the modifications and variations of the various embodiments described herein provided such modification and variations come within the scope of the appended claims and their equivalents.

Having described the subject matter herein in detail and by reference to specific embodiments, it is noted that the various details disclosed herein should not be taken to imply that these details relate to elements that are essential components of the various embodiments described herein. Further, it will be apparent that modifications and variations are possible without departing from the scope herein, including, but not limited to, embodiments defined in the appended claims.

What is claimed is:

1. A system for determining conditions within a pipeline, the system comprising:
a testing platform comprising:
a magnetically attractable component; and
at least one testing component;
a magnetic positioning system comprising:
a platform engaging magnet; and
a three-dimensional positioner configured to position the platform engaging magnet longitudinally and circumferentially along an exterior surface of the pipeline,
wherein the magnetic positioning system is configured to selectively maintain the testing platform at a plurality of positions within the pipeline via through-wall magnetic coupling between the platform engaging magnet and the magnetically attractable component of the testing platform.

2. The system of claim 1, wherein the magnetically attractable component of the testing platform and the platform engaging magnet of the magnetic positioning system define a magnetic coupling force of at least about 0.039 newtons (N).

3. The system of claim 1, wherein the testing platform comprises a hollow enclosure, and wherein:
the magnetically attractable component is associated with the hollow enclosure; and
the at least one testing component is disposed within an interior portion of the hollow enclosure.

4. The system of claim 3, wherein the hollow enclosure comprises the magnetically attractable component.

5. The system of claim 3, wherein the magnetically attractable component is rigidly secured to the hollow enclosure.

6. The system of claim 3, wherein the magnetically attractable component is tethered to the hollow enclosure.

7. The system of claim 3, wherein the interior portion of the hollow enclosure is fluidly sealed from an exterior portion of the hollow enclosure.

8. The system of claim 3, wherein the interior portion of the hollow enclosure is fluidly connected with an exterior portion of the hollow enclosure.

9. The system of claim 1, wherein the testing platform comprises:
a base comprising the magnetically attractable component; and
at least one attachment structure,
wherein each attachment structure of the at least one attachment structure is configured for the attachment of a respective testing component of the at least one testing component.

10. The system of claim 9, wherein the at least one attachment structure comprises a plurality of attachment structures configured for the attachment of respective testing components of the at least one testing component.

11. The system of claim 10, wherein:
each of the plurality of attachment structures are coupled to the base via a respective support member; and
the plurality of attachment structures are arranged in a radial array around the base.

12. The system of claim 1, wherein the at least one testing component comprises a sensor.

13. The system of claim 12, wherein the sensor comprises an ultrasonic sensor, a pressure sensor, or a temperature sensor.

14. The system of claim 1, wherein the at least one testing component comprises a camera.

15. The system of claim 1, further comprising an injection system configured to introduce the testing platform into the pipeline.

16. A method for determining conditions within a pipeline, the method comprising:
(a) positioning a platform engaging magnet at a first external position of the pipeline;
(b) introducing a testing platform into the pipeline, the testing platform comprising a magnetically attractable component and at least one testing component;
(c) attracting the testing platform to an initial position adjacent to the first external position via through-wall magnetic coupling between the platform engaging magnet and the magnetically attractable component of the testing platform;
(d) moving the platform engaging magnet longitudinally and/or circumferentially along an exterior surface of the pipeline to a second external position of the pipeline, thereby causing movement of the testing platform to a measurement position adjacent to the second external position; and
(e) performing at least one measurement at the measurement position with the at least one testing component to determine conditions associated with the measurement position.

17. The method of claim 16, wherein the conditions comprise at least one of scale thickness, pressure, or temperature.

18. The method of claim 16, wherein the at least one testing component comprises a camera and the at least one measurement comprises at least one image.

19. The method of claim 16, wherein the platform engaging magnet is moved longitudinally and circumferentially along the exterior surface of the pipeline to the second external position of the pipeline.

20. The method of claim 16, wherein (b) comprises introducing the testing platform into the pipeline using an injection system.

21. The method of claim 16, further comprising:
(f) moving the platform engaging magnet longitudinally and/or circumferentially along the exterior surface of the pipeline to another external position of the pipeline, thereby causing movement of the testing platform to another measurement position adjacent to the another external position of the pipeline; and
(g) performing at least one measurement at the another measurement position with the at least one testing component to determine conditions associated with the another measurement position.

22. The method of claim 21, wherein (f) and (g) are repeated a plurality of times to determine conditions at a plurality of measurement positions within the pipeline.

23. A method for determining a characterization profile of the pipeline, the method comprising:
(h) performing the method of claim 22; and
(i) processing the conditions determined for the plurality of measurement positions to determine the characterization profile.

24. The method of claim 23, wherein the method further comprises wirelessly transmitting signals associated with the conditions determined in (h) to a receiver that is external to the pipeline.

25. The method of claim 23, wherein the method further comprises:
storing data associated with the conditions determined in (h) on a memory module of the testing platform;
removing the testing platform from the pipeline; and
extracting the data associated with the conditions determined in (h) from the memory module.

26. A system for determining conditions within a hollow structure, the system comprising:
a testing platform comprising:
a magnetically attractable component; and
at least one testing component;
a magnetic positioning system comprising:
a platform engaging magnet; and
a three-dimensional positioner configured to position the platform engaging magnet longitudinally and circumferentially along an exterior surface of the hollow structure,
wherein the magnetic positioning system is configured to selectively maintain the testing platform at a plurality of positions within the hollow structure via through-wall magnetic coupling between the platform engaging magnet and the magnetically attractable component of the testing platform.

27. A testing platform comprising:
a hollow enclosure;
a magnetically attractable component that is tethered to the hollow enclosure; and
at least one testing component is disposed within an interior portion the hollow enclosure.

28. The testing platform of claim 27, wherein the interior portion of the hollow enclosure is fluidly sealed from an exterior portion of the hollow enclosure.

29. The testing platform of claim 27, wherein the interior portion of the hollow enclosure is fluidly connected with an exterior portion of the hollow enclosure.

30. A testing platform comprising:
at least one testing component; and
a base comprising:
a magnetically attractable component; and
a plurality of attachment structures configured for the attachment of respective testing components of the at least one testing component,
wherein:
each of the plurality of attachment structures are coupled to the base via a respective support member; and
the plurality of attachment structures are arranged in a radial array around the base.
